(19) United States
(12) Patent Application Publication
(10) Pub. No.: US 2015/0002356 A1
(43) Pub. Date: Jan. 1, 2015

(54) TUBE AND RING DIRECTIONAL END-FIRE ARRAY ANTENNA

(71) Applicant: PC-TEL, Inc., Bloomingdale, IL (US)

(72) Inventor: David Edward Urbasic, Saint Charles, IL (US)

(21) Appl. No.: 14/311,535

(22) Filed: Jun. 23, 2014

Related U.S. Application Data
(60) Provisional application No. 61/840,212, filed on Jun. 27, 2013.

(51) Int. Cl. H01Q 21/29; H01Q 1/42

(52) U.S. Cl. CPC H01Q 21/29; H01Q 1/42
USPC 343/832; 343/872; 343/833; 29/600

(57) ABSTRACT

A tube and ring directional end-fire array antenna is provided. The antenna can include a radome, a reflector housing disposed at a first end of the radome, a driven PCB element housed within the radome, a plurality of RF feed connectors disposed on a distal side of the reflector housing and electrically coupled to the driven PCB element, via the reflector housing, and a plurality of assemblies stacked within the radome. The geometry of the plurality of assemblies stacked within the radome can determine a radiation pattern performance of the antenna.

### CROSS-REFERENCE TO RELATED APPLICATIONS

This application claims priority to U.S. Provisional Patent Application No. 61/840,212 filed Jun. 27, 2013 and titled “Tube and Ring Directional Antenna”. U.S. Application No. 61/840,212 is hereby incorporated by reference.

### FIELD

The present invention relates generally to antennas. More particularly, the present invention relates to a tube and ring directional end-fire array antenna.

### BACKGROUND

When an antenna with some directivity is desired, a directional end-fire array antenna is often considered. For example, a Yagi-Uda antenna, or a Yagi antenna, is a known directional end-fire antenna consisting of a reflector element, a driven dipole element, and a series of parasitic director elements. In these antennas, element spacing and length determine performance.

When a vertical polarized antenna and a horizontal polarized antenna are both required, common practice is to co-locate two Yagi arrays. Alternatively, a single dual polarized Yagi antenna can be employed, although often with a reduced size. For example, the dual polarized Yagi antenna can include two sets of elements mounted orthogonally and two ports, and the structure can operate as a vertically polarized antenna on one port and a horizontally polarized antenna on a second port.

When an end-fire array or a Yagi antenna is designed with a single polarization, it is critical to align the reflector, driven, and director elements. Accordingly, when a single Yagi antenna structure is employed for both horizontal and vertical polarizations, the reflector, driven, and director elements must be consistently aligned parallel to a first polarization and orthogonal to a second polarization.

It is known to align the elements with respect to the horizontal and vertical polarizations in a Yagi antenna with any one or combination of the following designs: (1) soldering or welding the reflector, driven, and director elements to a central support beam, (2) cutting the elements out of a rigid conductive material, such as aluminum or brass, and (3) eliminating costly metal parts and labor, but adding an expensive printed circuit board (PCB) onto which the elements can be etched. In any of these designed, the elements for each polarization can be aligned orthogonally by rigid structures of metal, PCB, and plastic to achieve the necessary precise parallel and orthogonal positioning. However, each of these designs incudes a variety of disadvantages, which will be explained in more detail herein.

For example, as explained above, elements in known Yagi antennas can be precision fabricated out of metal or a PCB. However, such precision fabrication can be costly, both from a manufacturing and a raw materials viewpoint. For example, known PCB-based Yagi antennas must be assembled and soldered together orthogonally, metal designs must be soldered, brazed or welded to a support boom and affixed to other alignment structures, and stamped designs must be aligned orthogonally and fastened to a support structure.

Another disadvantage relates to antenna performance. For example, in addition to other parameters, gain and beamwidth of known Yagi antennas are generally defined by how many properly sized and spaced director elements are included in the Yagi antenna. However, in known solutions, increasing or decreasing the elements can be difficult and often involves changes to the element support structure. In stamped designs, an entirely new support structure must often be fabricated.

Yet another disadvantage of known Yagi antennas includes the assembly thereof. For example, in known Yagi antennas, a boom can be included as a central support member, and the reflector, driven, and director elements can be affixed to the boom to help maintain parallel spacing of the elements. The boom can be formed from a rigid material, such as metal, and the elements can be affixed to the boom with fasteners, welding, or soldering. However, assembling antenna elements to a boom is a labor intensive process. Furthermore, in stamping designs, when elements and a boom are fabricated as a single part, any changes require new or modified tooling.

Finally, Yagi elements often scale inversely as frequency increases. Accordingly, Yagi antennas are often made up of small elements, and a radome is added to protect the delicate elements and to act as a support structure. However, the radome is yet another added expense and may not eliminate the internal support structure required in known Yagi antennas.

In view of the above, there is a need for an improved dual polarized antenna.

### BRIEF DESCRIPTION OF THE DRAWINGS

FIG. 1 is a first perspective view of a dual polarized tube and ring directional end-fire array antenna in accordance with disclosed embodiments;

FIG. 2 is a second perspective view of a dual polarized tube and ring directional end-fire array antenna in accordance with disclosed embodiments;

FIG. 3 is a cross-sectional view of an assembled dual polarized tube and ring directional end-fire array antenna in accordance with disclosed embodiments;

FIG. 4 is a perspective view of an element-spacer assembly, including a metallic element and a spacer element, in accordance with disclosed embodiments;

FIG. 5A is a schematic view of a conductive trace layer of a PCB element in accordance with disclosed embodiments;

FIG. 5B is a schematic view of a PCB outline layer of a PCB element in accordance with disclosed embodiments;

FIG. 5C is a schematic view of a conductive trace layer of a PCB element in accordance with disclosed embodiments;

FIG. 6A is a perspective view of an element-carrier assembly in accordance with disclosed embodiments; and

FIG. 6B is a perspective view of an individual spacer element in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include an improved dual polarized antenna that can address and overcome some of the above-identified deficiencies and disadvantages of known end-fire arrays, including known Yagi-Uda style dual polarized directional antennas. For example, the antenna disclosed herein can include a dual polarized tube and ring directional end-fire array antenna.

The tube and ring directional end-fire array antenna disclosed herein can be utilized in various industries, including telecommunications, wireless infrastructure, and the like. Furthermore, the tube and ring directional end-fire array antenna disclosed herein can be used in any wireless system that requires a directional antenna for point-to-point communication or for point-to-multipoint communication.

Some embodiments disclosed herein include a dual polarized directional antenna operating at a frequency of approximately 5-6 GHz. However, it is to be understood that embodiments disclosed herein are not so limited. For example, embodiments of the tube and ring directional end-fire array antenna disclosed herein can be optimized for different frequencies, higher or lower gain, and/or different performance patterns. Furthermore, embodiments of the tube and ring directional end-fire array antenna disclosed herein can include variations in polarization, including circular, elliptical, linear, or other variations of multi-port and multi-polarization.

In accordance with disclosed embodiments, the dual polarized tube and ring directional end-fire array antenna disclosed herein can remove the need for individual horizontally and vertically polarized directional antennas. For example, the tube and ring directional end-fire array antenna disclosed herein can include a disc element as a driven radiating element, a disc element as a reflector element, and a ring element as a director element.

The disc and ring elements can have substantially perfect symmetry at any one angle in a plane. Accordingly, the disc and ring elements can be employed for a single polarization, a dual orthogonal polarization, a phased elliptical polarization, multi-polarization, or the like without the need for individual elements for each polarization. Furthermore, the disc and ring elements can simplify the antenna structure as compared to known multi-polarization Yagi antennas while promoting cost savings by reusing parts.

In accordance with disclosed embodiments, the dual polarized tube and ring directional end-fire array antenna disclosed herein can eliminate clocking issues that often arise when aligning multiple director elements in a known Yagi-Uda style dual polarized directional antenna. For example, because of the perfect symmetry of the director elements in one plane of the antenna disclosed herein, there is no need for additional structures to rigidly align the elements. Accordingly, the antenna in accordance with disclosed embodiments can reduce cost and complexity.

In accordance with disclosed embodiments, the dual polarized tube and ring directional end-fire array antenna disclosed herein can reduce the cost of fabrication of elements, including director elements, as compared to known Yagi-Uda style dual polarized directional antennas. For example, in some embodiments, the elements disclosed herein can include an element-spacer assembly that includes a thin, metallic foil embossed onto a rigid dielectric foam. The metallic foil can be die-cut or trimmed into a ring shape or disc shape, as needed, by any means as would be known by those or ordinary skill in the art. Additionally, the dielectric foam can be die-cut or otherwise shaped to support the thin, metallic element and to provide the required elemental spacing between each element. Accordingly, the element-spacer assembly of disclosed embodiments can utilize common and low cost manufacturing techniques.

In some embodiments, the elements and the spacers need not be bonded to one another. For example, the elements can include a thin, metallic foil bonded to a dielectric carrier to form an element-carrier assembly. The dielectric carrier can be appropriately die-cut or otherwise shaped and appropriately sized to support the thin, metallic element.

In accordance with disclosed embodiments, the dual polarized tube and ring directional end-fire array antenna disclosed herein can also reduce the cost of installation of elements, including direct elements, as compared to known Yagi-Uda style dual polarized directional antennas. For example, in some embodiments, assembly of the director elements disclosed herein can include stacking a number of element-spacer assemblies to be used as directors. Additionally or alternatively, in some embodiments, assembly of the director elements disclosed herein can include stacking in an alternating matter a number of element-carrier assemblies with a number of spacer elements to be used as directors. Accordingly, in some embodiments, it is not necessary to fasten, solder, or weld the elements of the disclosed antenna. Furthermore, in some embodiments, it is not necessary to use complex tooling to stamp elements out of metal or to use a PCB material as a support structure for the directors.

In accordance with disclosed embodiments, the dual polarized tube and ring directional end-fire array antenna disclosed herein can simplify the modification of the platform in terms of the number of director elements and/or the gain. For example, as explained above, each element of the disclosed antenna can include a die-cut foil element embossed onto a die-cut foam spacer or bonded to a die-cut dielectric carrier. The variables that define each of these element-spacer assemblies, or each of these element-carrier assemblies stacked with individual spacer assemblies, can include the geometry of the ring or disc and the thickness of the foam. Accordingly, when the element-spacer assemblies are stacked, or when the element-carrier assemblies are stacked with individual spacer assemblies, the geometry of the stack can determine the radiation pattern performance of the disclosed antenna, including the gain, half power beamwidth, side lobes, and other parameters as would be known by those of skill in the art.

In some embodiments, antenna performance can be adjusted by varying the element-spacer assemblies or the element-carrier assemblies and/or by stacking more or less element-spacer assemblies, element-carrier assemblies, and/or individual spacer elements. This method of varying performance is superior to known Yagi antennas that require an entirely new support structure and elements to change an antenna from having one set of performance parameters to another set of performance parameters.

Furthermore, while not required, the element-spacer assemblies, the element-carrier assemblies, and the individual spacer elements disclosed herein can be reused. For example, in some embodiments, the antenna disclosed herein can include a directional antenna in which the majority of the element geometry and the element spacing are identical. That is, the antenna disclosed herein can be optimized such that the directors, including the element-spacer assemblies, or the element-carrier assemblies and the individual spacer elements, are identical regardless of whether the antenna requires 5, 10, or n directors. Accordingly, the antenna disclosed herein can achieve great economy of scale because the same elements can be stacked onto each other until the desired performance is achieved.

In accordance with disclosed embodiments, the dual polarized tube and ring directional end-fire array antenna disclosed herein can eliminate a boom structure common in known Yagi-Uda dual polarized directional antennas. For example, the antenna disclosed herein can employ rigid foam to ensure parallel and properly spaced elements. That is, in some embodiments, the boom structure in known Yagi antennas can be effectively replaced by the rigid foam. Accordingly, the labor and material costs can be saved, the need to affix elements to a boom member can be eliminated, and, in PCB or stamped designs, the cost of the boom material can be eliminated.

In accordance with disclosed embodiments, the dual polarized tube and ring directional end-fire array antenna disclosed herein can also provide a protective radome enclosure to the antenna assembly. The protective radome can include a tube or otherwise hollow structure to house the antenna elements and spacers, thereby facilitating the disclosed antenna elements and spacers to be realized in low cost and/or delicate materials without sacrificing durability or electrical performance.

For example, the antenna disclosed herein can include a tube or otherwise hollow structure in lieu of a more costly and complex support structure. In some embodiments, the radome can align the element-spacer assemblies, the element-carrier assemblies, and/or the individual spacer elements within the radome. This is facilitated, in part by the symmetrical nature of the element-spacer assemblies, the element-carrier assemblies, and the individual spacer elements, thereby eliminating keying features and the like that would otherwise be necessary for positioning the element-spacer assemblies, the element-carrier assemblies, and the individual spacer elements within the radome.

In some embodiments, the radome can include a cylindrical tube. However, in some embodiments, the radome can include a non-cylindrical tube. For example, a radome having a square or other shaped cross-section can be used in connection with symmetrical, non-symmetrical, and/or round element-spacer assemblies, element-carrier assemblies, and/or individual spacer elements.

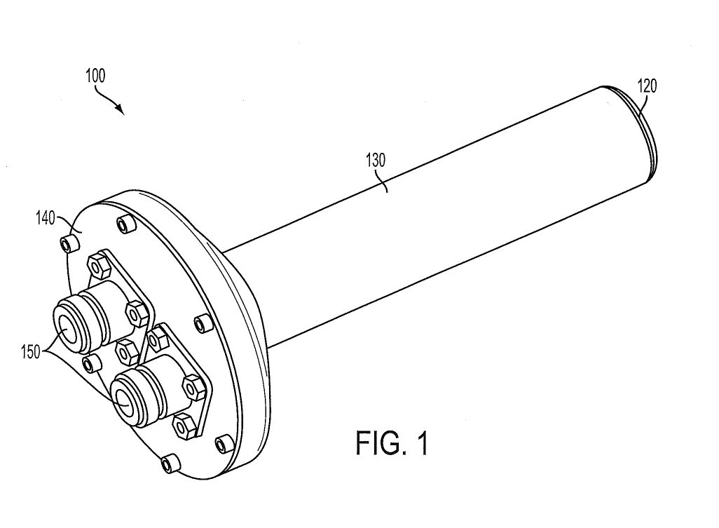

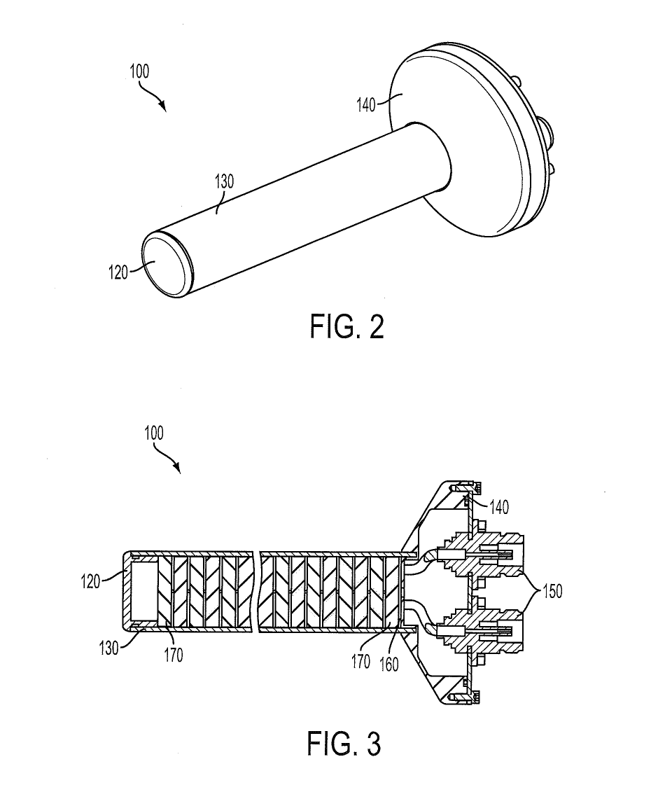

FIG. 1 and FIG. 2 are first and second perspective views, respectively, of a dual polarized tube and ring directional end-fire array antenna 100 in accordance with disclosed embodiments. As seen, the antenna 100 can include a tubular radome and external support structure 130 having first and second ends. A radome cap 120 can be disposed at a first end of the structure 130, and a reflector housing 140 can be disposed at a second end of the structure 130. Furthermore, a plurality of RF feed connectors 150 can be disposed on a distal side of the reflector housing 140. For example, first and second RF feed connectors 150 are shown in FIG. 1.

FIG. 3 is a cross-sectional view of an assembled dual polarized tube and ring directional end-fire array antenna 100 in accordance with disclosed embodiments. As seen in FIG. 3, the tubular radome and external support structure 130 can house a plurality of element-spacer assemblies 170. For example, the element-spacer assemblies 170 can be stacked on top of one another within the structure 130. Alternatively, the tubular radome and external support structure 130 can house a plurality of element-carrier assemblies 1500 stacked in an alternating manner with a plurality of individual spacer elements 180 within the structure 130.

The structure 130 can also house a driven PCB element 160 at or near the second end thereof. Accordingly, the plurality of RF feed connectors 150 can be electrically connected to the driven PCB element 160 and/or elements and traces disposed, etched, and/or deposited thereon. For example, portions of the RF feed connectors 150 can be disposed through the reflector housing 140 to connect with the PCB element 160.

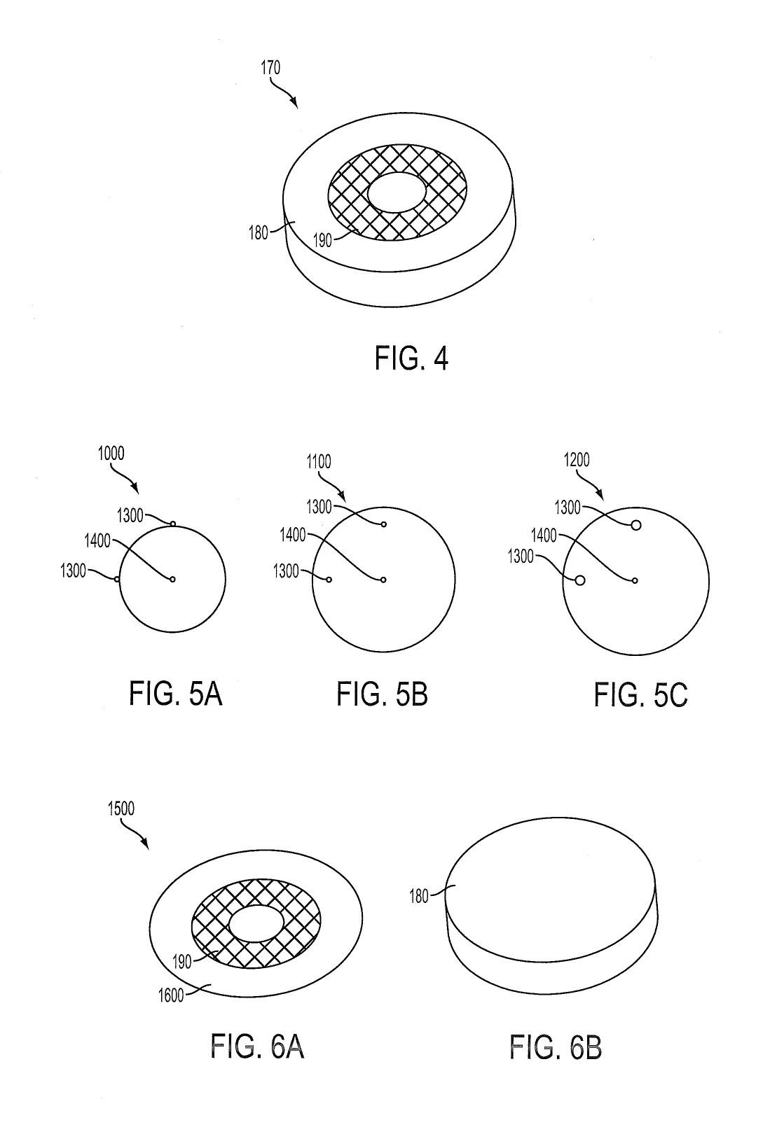

FIG. 4 is a perspective view of an element-spacer assembly 170, including a metallic element 190 and a spacer element 180, in accordance with disclosed embodiments. The metallic element 190 can act as a radiating element and a reflector element for the antenna 100, and the spacer element 180 can act as a director element for the antenna 100. Furthermore, as seen, the spacer element 180 and the metallic element 190 can have substantially perfect symmetry. For example, in some embodiments, the spacer element 180 and the metallic element 190 can be circular.

In some embodiments, the metallic element 190 can include a thin, metallic foil that is die-cut or trimmed into its desired shape. In some embodiments, the spacer element 180 can include a rigid dielectric foam that is die-cut or otherwise shaped into its desired shape. However, embodiments disclosed herein are not so limited. For example, the spacer element 180 can include a dielectric foam or any other dielectric material as would be known by one of ordinary skill in the art, including, but not limited to, a molded plastic or a phenolic honeycomb structure. In some embodiments, the metallic element 190 can be embossed or otherwise applied onto the spacer element 180, and the spacer element 180 can provide support to the metallic element 190 while also providing a desired spacing between each metallic element 190 within the structure 130.

FIG. 6A is a perspective view of an element-carrier assembly 1500 in accordance with disclosed embodiments, and FIG. 6B is a perspective view of an individual spacer element 800 in accordance with disclosed embodiments. The metallic element 190 can act as a radiating element and a reflector element for the antenna 100, and the spacer element 180 can act as a director element for the antenna 100. Furthermore, as seen, the metallic element 190, the spacer element 190, and a carrier element 1600 can have substantially perfect symmetry. For example, in some embodiments, the spacer element 180, the metallic element 190, and the carrier element 1600 can be circular.

In some embodiments, the metallic element 190 can include a thin, metallic foil that is die-cut or trimmed into its desired shape. In some embodiments, the carrier element 1600 can include a dielectric and/or a metal that is die-cut or trimmed into its desired shape. In some embodiments, the spacer element 180 can include a rigid dielectric foam that is die-cut or otherwise shaped into its desired shape. However, embodiments disclosed herein are not so limited. For example, the spacer element 180 can include a dielectric foam or any other dielectric material as would be known by one of ordinary skill in the art, including, but not limited to, a molded plastic or a phenolic honeycomb structure. In some embodiments, the metallic element 190 can be bonded to the carrier element 1600, which can provide support to the metallic element 190. Furthermore, a plurality of element-carrier assemblies 1500 can be stacked in an alternating manner with a plurality of individual spacer elements 180 to provide the desired spacing between each metallic element 190 within the structure 130.

FIGS. 5A-5C are schematic views of conductive trace layers 1000, 1200 and a PCB outline layer 1100 of the PCB element 160 in accordance with disclosed embodiments. For example, FIG. 5A illustrates a top copper layer 1000 of the driven PCB element 160, FIG. 5B illustrates a PCB outline layer 1100 of the PCB element 160, and FIG. 5C illustrates a bottom copper layer 1200 of the PCB element 160. As seen, first and second orthogonal feed points 1300 can be etched onto the bottom copper layer 1200 and disposed through the PCB outline layer 1100 so that the feed points 1300 are disposed adjacent to an outer edge of the top copper layer 1000. As also seen, a DC shorting point 1400 can be etched onto each of the top copper layer 1000 and the bottom copper layer 1200 and disposed through the PCB outline layer 1100.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. An antenna comprising:
a radome;
a reflector housing disposed at a first end of the radome;
a driven PCB element housed within the radome;
a plurality of RF feed connectors disposed on a distal side of the reflector housing and electrically coupled to the driven PCB element, via the reflector housing; and
a plurality of assemblies stacked within the radome,
wherein a geometry of the plurality of assemblies stacked within the radome determines a radiation pattern performance of the antenna.

2. The antenna as in claim 1 wherein each of the plurality of assemblies has substantially perfect symmetry at any one angle in a plane.

3. The antenna as in claim 2 wherein each of the plurality of assemblies is circular.

4. The antenna as in claim 1 wherein each of the plurality of assemblies incudes a disc element and a ring element.

5. The antenna as in claim 4 wherein the disc element acts as a radiating element and a reflector element.

6. The antenna as in claim 4 wherein the ring element acts as a director element.

7. The antenna as in 4 wherein the disc element includes a metallic disc element, wherein the ring element incudes a rigid dielectric material, and wherein the metallic disc element is embossed onto the rigid dielectric material.

8. The antenna as in claim 7 wherein the rigid dielectric material supports the metallic disc element, and wherein the rigid dielectric material provides a predetermined spacing between each of the plurality of metallic disc elements.

9. The antenna as in claim 4 wherein the disc element includes a metallic disc element, wherein the ring element includes a dielectric carrier, wherein the metallic disc element is bonded to the dielectric carrier.

10. The antenna as in claim 9 wherein the plurality of assemblies is alternatingly stacked with a plurality of spacer elements within the radome, wherein each of the plurality of spacer elements includes a rigid dielectric material, and wherein the rigid dielectric material provides a predetermined spacing between each of the plurality of assemblies.

11. The antenna as in claim 1 wherein the radome includes a hollow structure that protects the plurality of assemblies stacked therein and that aligns the plurality of assemblies stacked therein.

12. The antenna as in claim 1 wherein a cross-section of the radome is circular.

13. The antenna of claim 1 having a single polarization, a dual orthogonal polarization, or a multi-polarization.

14. The antenna of claim 1 having a circular polarization, an elliptical polarization, or a linear polarization.

15. A method of varying antenna performance comprising:
providing a radome;
providing a reflector housing disposed at a first end of the radome;
providing a driven PCB element housed within the radome;
providing a plurality of RF feed connectors disposed on a distal side of the reflector housing;
electrically coupling each of the plurality of RF feed connectors to the driven PCB element, via the reflector housing;
stacking a plurality of assemblies within the radome; and
adjusting a geometry of the plurality of assemblies stacked within the radome to adjust a radiation pattern performance of the antenna.

16. The method of claim 15 wherein adjusting a geometry of the plurality of assemblies stacked within the radome includes stacking more or less assemblies within the radome.

17. The method of claim 15 wherein each of the plurality of assemblies stacked within the radome includes a disc element acting as a radiator element and a reflector element, and wherein adjusting a geometry of the plurality of assemblies stacked within the radome includes adjusting a geometry of each of the disc elements.

18. The method of claim 15 wherein each of the plurality of assemblies stacked within the radome includes a ring element acting as a director element, and wherein adjusting a geometry of the plurality of assemblies stacked within the radome incudes adjusting a thickness of each of the ring elements.

19. The method of claim 15 further comprising alternatingly stacking the plurality of assemblies with a plurality of spacer elements within the radome, wherein adjusting a geometry of the plurality of assemblies stacked within the radome includes adjusting a thickness of each of the plurality of spacer elements.

20. The method of claim 15 wherein adjusting the radiation pattern performance of the antenna includes adjusting at least one of gain, half power beamwidth, and side lobes of the radiation pattern.
